(19) United States
(12) Patent Application Publication
(10) Pub. No.: US 2005/0188391 A1
(43) Pub. Date: Aug. 25, 2005

(54) Transport roller for a disk recording and/or reproducing device

(75) Inventors: Jui-Chiang Lin, Hsinchu City (TW); Tsung-Jung Kuo, Hsinchu City (TW)

Correspondence Address: BRUCE H. TROXELL, SUITE 1404, 5205 LEESBURG PIKE, FALLS CHURCH, VA, 22041, US

(73) Assignee: LITE-ON IT Corp.

(21) Appl. No.: 11/050,755

(22) Filed: Feb. 7, 2005

(30) Foreign Application Priority Data
Feb. 20, 2004 (TW) 93202467

(51) Int. Cl. G11B 17/03

(52) U.S. Cl. 720/621; 720/601

(57) ABSTRACT

A transport roller for a disk recording and/or reproducing device includes a bearing axle, two tubular sleeves sleeved respectively on outer surfaces of left and right end portions of the bearing axle, and a spacer member mounted on an intermediate portion of the bearing axle for spacing the tubular sleeves apart from each other. The spacer member has an outer diameter that is greater than an outer diameter of the bearing axle and that is equivalent to or is smaller than the greatest outer diameter of a respective one of the tubular sleeves.

### FIELD OF THE INVENTION

The invention relates to a transport roller, more particularly to a disk recording and/or reproducing device of slot-in type.

### BACKGROUND OF THE INVENTION

A disk recording and/or reproducing device of slot-in type is generally installed in a notebook computer or in an audio-and-video instrument of an automobile for reproducing the information recorded in an optical recording media, such as playing songs from a CD.

Referring to FIGS. 1 to 3, perspective, partly exploded and bottom views of a conventional disk recording and/or reproducing device 2 of slot-in type are shown to include a casing formed with a disk entrance-and-exit slot 20, and a disk transport mechanism 6 disposed in the casing adjacent to the entrance-and-exit slot 20. The disk transport mechanism 6 includes an upwardly biased transport roller 61 and a guide member 62 that is disposed stationarily above the transport roller 61 and that slidably contacts the transport roller 61 by virtue of upwardly biased action of a spring. Under this condition, when an optical disk 4 is inserted between the guide member 62 and the transport roller 61 via the entrance-and-exit slot 20, the optical disk 4 will be drawn into or ejected from the casing upon rotation of the transport roller 61 and due to applying force on the optical disk 4.

FIG. 4 illustrates a perspective view of the transport roller 61 which includes a bearing axle 8 and two tubular sleeves 10 sleeved respectively on the bearing axle 8 adjacent to the opposite ends thereof. The bearing axle 8 is made of metal while the tubular sleeves 10 are made from a resilient material, such as rubber to provide friction force during feeding or ejecting of the optical disk 4.

Some disadvantages resulting from the use of the aforesaid transport roller 61 are as follows:

(1) Loosening of the tubular sleeves 10 from the bearing axle 8 during rotation of the transport roller 61 can result in movement of the tubular sleeves 10 in the leftwise-and-rightwise direction, thereby causing damage to a signal-recording surface of the optical disk 4.

(2) The damage caused to the signal-recording surface the optical disk 4 will aggravate, in case the tubular sleeves 10 elastically deform after long-term use.

Referring to FIG. 5, a prior transport roller 61 is shown to include a bearing axle 8 and an elongated tubular sleeve 10 mounted on the bearing axle 8. The tubular sleeve 10 has a uniform diameter throughout the entire length thereof. However, leftwise-and-rightwise movement of the tubular sleeve 10 relative to the bearing axle 8 is still possible, in case there is disengagement between the tubular sleeve 10 and the bearing axle 8, which in turn, can cause damage to the signal-recording surface of the optical disk 4.

Referring to FIG. 6, a prior transport roller 61 is provided to overcome the disadvantages resulting from the use of the aforesaid transport rollers. As shown, the transport roller 61 includes a bearing axle 8, and two truncated cone-shaped sleeves 10a,10b sleeved on the bearing axle 8 and abutting against each other. Each of the truncated cone-shaped sleeves 10a, 10b has an outer diameter that gradually increases from an inner end to an outer end such that when the optical disk 4 is transported by the transport roller 61, only the outer peripheral portion of the signal recording surface of the optical disk 4 will contact the sleeves 10a, 10b. The entire area of the signal recording surface of the optical disk 4 is thus spaced apart from the sleeves 10a, 10b, thereby preserving the information recorded on the signal recording surface thereof. However, non-synchronous rotation of the sleeves 10a, 10b can result when the abutting ends of the sleeves 10a, 10b disengage from each other. In addition, in case of disengagement between the abutting ends of the tubular sleeves 10a, 10b, the latter may rotate in opposite directions on the bearing axle 8, which in turn, causes instability of the optical disk 4 during feed-in or ejecting operations.

### SUMMARY OF THE INVENTION

The object of the present invention is to provide a transport roller for use in a disk recording and/or reproducing device of slot-in type that can eliminate the aforesaid drawback resulting from the use of the transport roller of the conventional disk recording and/or reproducing device.

transport roller for use in a disk recording and/or reproducing device according to the present is provided to include: a bearing axle disposed within the disk recording and/or reproducing device, extending along left and right sides of the disk recording and/or reproducing device, and having left and right end portions and an intermediate portion between the left and right end portions; two tubular sleeves sleeved respectively on outer surfaces of the left and right end portions of the bearing axle; and a spacer member mounted on the intermediate portion of the bearing axle for spacing the tubular sleeves apart from each other. The spacer member has an outer diameter that is greater than an outer diameter of the bearing axle and that is equivalent to or is smaller than the greatest outer diameter of a respective one of the tubular sleeves.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 shows a perspective view a conventional disk recording and/or reproducing device;

FIG. 2 is a partly exploded and bottom view, illustrating an interior of the conventional disk recording and/or reproducing device;

FIG. 3 is a fragmentary sectional view of the conventional disk recording and/or reproducing device, illustrating how an optical disk is drawn into or ejected from the device;

FIG. 4 is a perspective view of a transport roller employed in the conventional disk recording and/or reproducing device;

FIG. 5 is a perspective view of another transport roller employed in the conventional disk recording and/or reproducing device;

FIG. 6 is a schematic side view of still another transport roller employed in the conventional disk recording and/or reproducing device;

FIG. 7 is a perspective and partly exploded view, illustrating the preferred embodiment of a disk recording and/or reproducing device according to the present invention shown together with an optical disk;

FIG. 8 is a perspective view of a transport roller employed the preferred embodiment of the disk recording and/or reproducing device according to the present invention;

FIG. 9 is a schematic side view of the transport roller shown in FIG. 8;

FIG. 10 is a schematic side view of another transport roller employed the preferred embodiment of the disk recording and/or reproducing device according to the present invention.

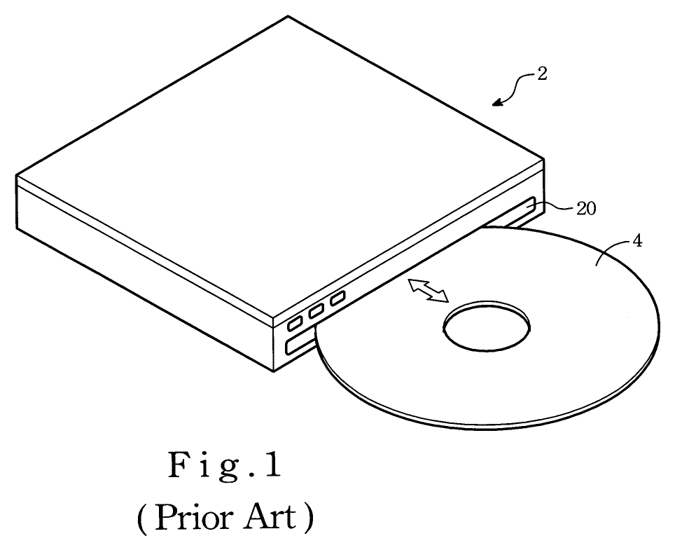

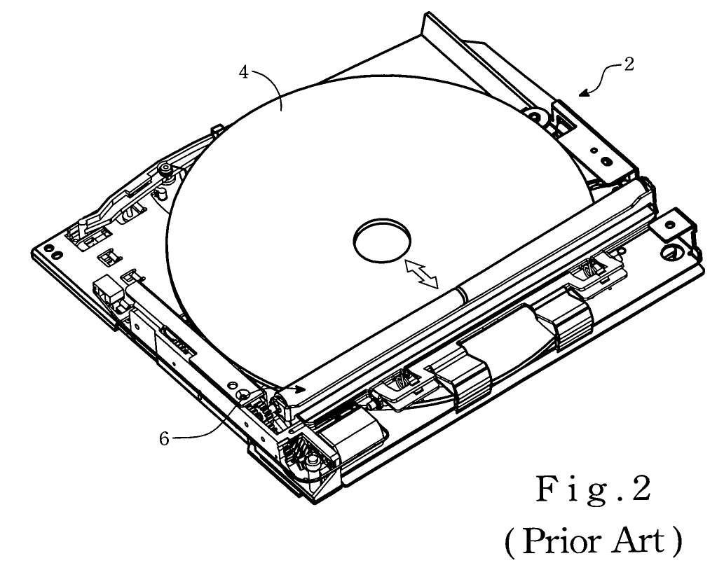

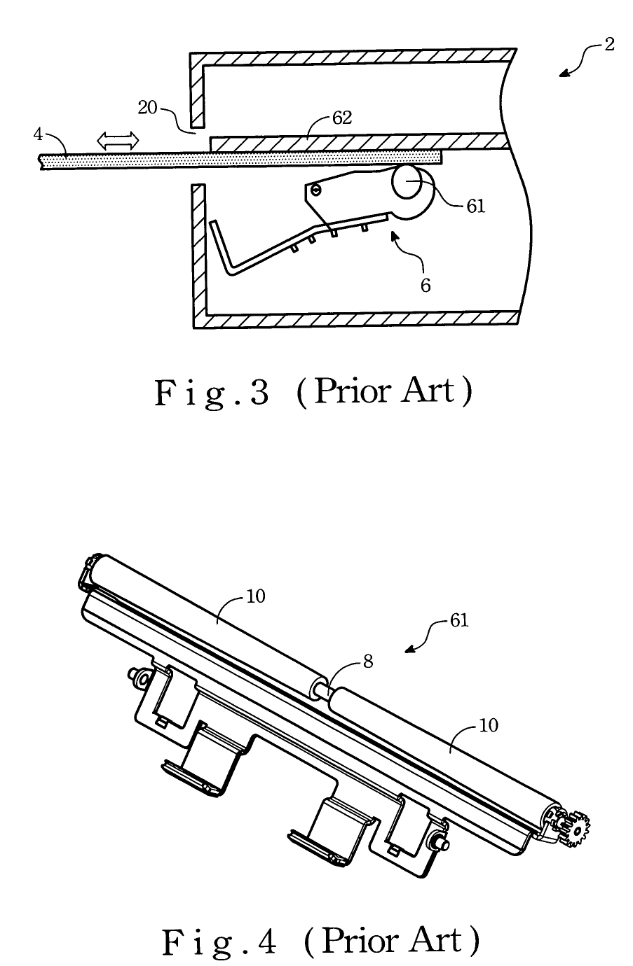

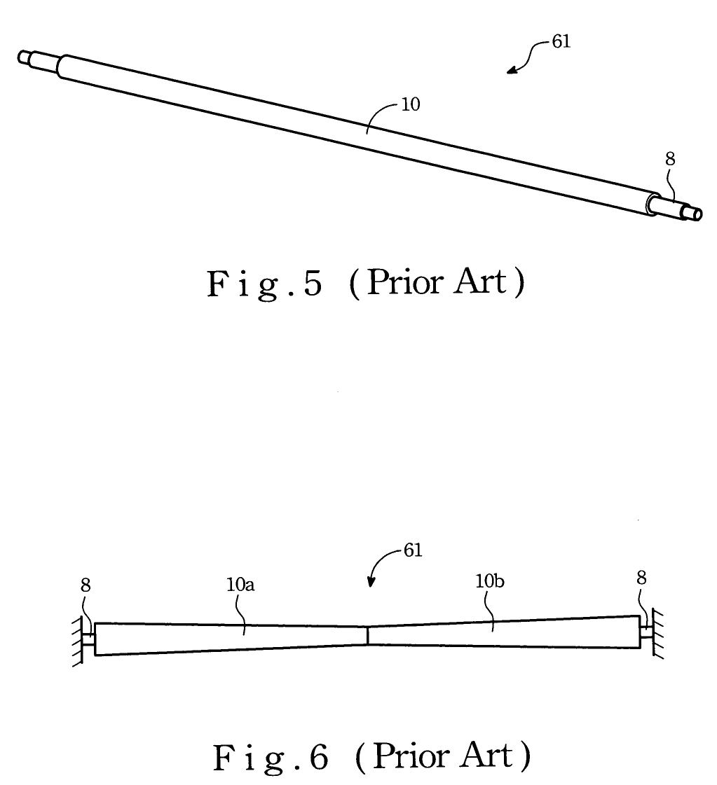

### DETAILED DESCRIPTIONS OF THE PREFERRED EMBODIMENT

Before the present invention is described in greater, it should be noted that same reference numerals have been used to denote similar elements throughout the specification.

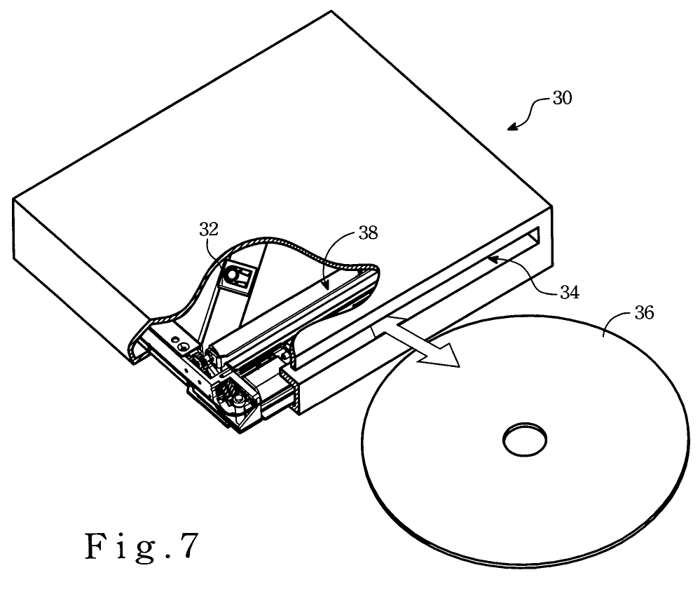

Referring to FIG. 7, a perspective and partly cutaway view of the preferred embodiment of a disk recording and/or reproducing device 30 of slot-in type is shown and generally installed in a notebook computer (not shown) or in an audio-and-video instrument of an automobile for reproducing the information recorded in a disk-like recording medium 36, such as an optical disk 36 and playing songs from a CD.

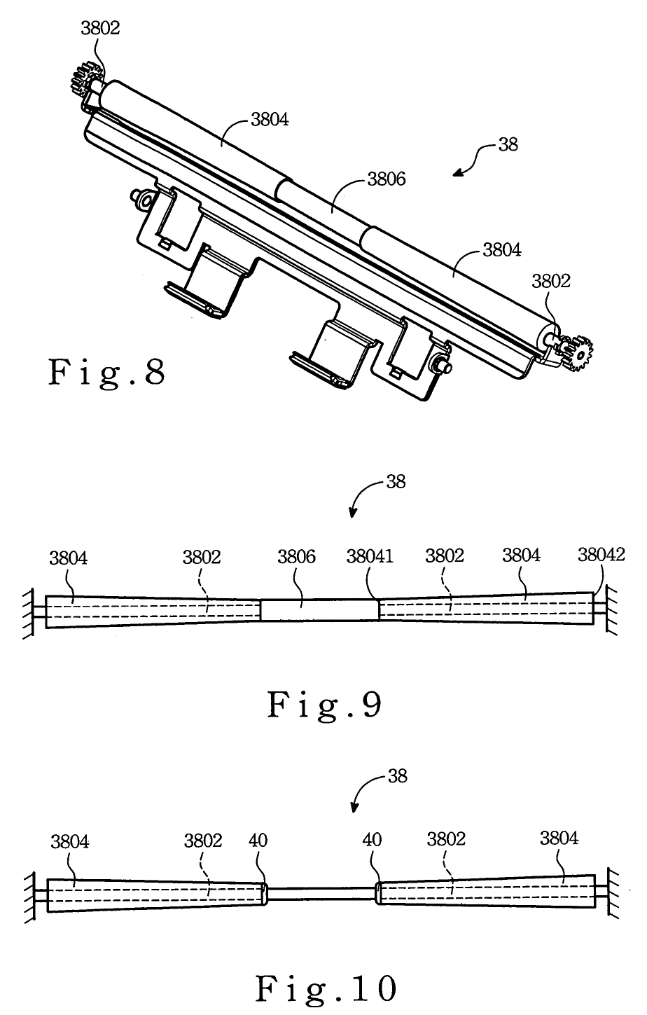

As illustrated, the device 30 includes a casing formed with an entrance-and-exit slot 34, a reading and/or writing head 32 for reading and/or writing the information recorded in the optical disk 36, and a disk transport mechanism. The transport mechanism includes a transport roller 38 (see FIG. 8). As to how the optical disk 36 is drawn into or ejected from the casing upon rotation of the transport roller 38 is not the relevant feature of the present invention, detailed description of the same is omitted herein for the sake of brevity.

Referring to FIG. 8, the transport roller 38 includes a bearing axle 3802, two tubular sleeves 3804, and a spacer member 3806. Preferably, the bearing axle 3802 has a length greater than a longitudinal length of the entrance-and-exist slot 34. When the bearing axle 3802 is disposed within the disk recording and/or reproducing device 30, the bearing axle 3802 extends along left and right sides of the entrance-and-exit slot 34, and has left and right end portions and an intermediate portion between the left and right end portions.

The spacer member 3806 is mounted on the intermediate portion of the bearing axle 3802. The tubular sleeves 3804 are sleeved respectively on outer surfaces of the left and right end portions of the bearing axle 3802 so as to be spaced apart from each other by the spacer member 3806. Then, the left and right end portions of the bearing axle 3802 are respectively mounted to two mounting walls (not shown) disposed within the casing. In this preferred embodiment, the spacer member 3806 is preferably a hollow cylinder, and has an outer diameter that is greater than an outer diameter of the bearing axle 3802 and that is equivalent to or is smaller than the greatest outer diameter of a respective one of the tubular sleeves 3804. The spacer member 3806 can be integrally formed on the intermediate portion of the bearing axle 3802 so as to prevent disengagement of the same from the bearing axle 3802.

FIG. 9 is a schematic side view of the transport roller shown in FIG. 8. As shown, each of the tubular sleeves 3804 has an inner end (38041) proximate to the intermediate portion of the bearing axle 3802, and an outer end (38042) opposite to the inner end (38041). The outer end (38042) of a respective one of the tubular sleeves 3804 has an outer diameter that is greater than outer diameter of the inner end 38041 of the respective one of the tubular sleeves 3804 and that defines the greatest outer diameter of the respective one of the tubular sleeves 3804. Each of the tubular sleeves 3804 is made from a resilient material, such as rubber to provide friction force when they are used to abut against the signal-recording surface of the optical disk 36. Since the diameter of each of the tubular sleeves 3804 gradually increases from the inner end 38041 toward the outer end 38042, only the outer peripheral portion of the signal-recording surface of the optical disk 36 will contact the tubular sleeves 3804 during the feed-in or ejecting operation of the optical disk. Preferably, the inner ends of the tubular sleeves 3804 can be coupled securely to the spacer member 3806 to prevent non-synchronous rotation of the tubular sleeves 3804 on the bearing axle 3002. When the tubular sleeves 3804 are thus arranged, rotation of the tubular sleeves 3804 in opposite directions that happened in prior art can be prevented.

Referring to FIG. 10, a schematic side view of another transport roller 38 is shown to have a construction similar to the aforesaid transport roller. The only difference resides in that the spacer member includes two annular flanges 40 respectively fixed on opposite sides of the intermediate portion of the bearing axle 3802 for spacing the tubular sleeves 3804 apart from each other.

When the transport roller 38 according to the present invention is employed in the disk recording and/or reproducing device, the disadvantage resulting from leftwise-and-rightwise movement of the tubular sleeve 3804 relative to the bearing axle 3802 can be avoided.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A transport roller for a disk recording and/or reproducing device, the transport roller being used for drawing and ejecting a disk-like recording medium into and from the device, the transport roller comprising:
a bearing axle disposed within the disk recording and/or reproducing device, extending along left and right sides of the disk recording and/or reproducing device, and having left and right end portions and an intermediate portion between said left and right end portions;
two tubular sleeves sleeved respectively on outer surfaces of said left and right end portions of said bearing axle; and
a spacer member mounted on said intermediate portion of said bearing axle for spacing said tubular sleeves apart from each other, wherein said spacer member has an outer diameter that is greater than an outer diameter of said bearing axle and that is equivalent to or is smaller than the greatest outer diameter of a respective one of said tubular sleeves.

2. The transport roller for a disk recording and/or reproducing device according to claim 1, wherein each of said tubular sleeves is made from a resilient material.

3. The transport roller for a disk recording and/or reproducing device according to claim 2, wherein said resilient material is rubber.

4. The transport roller for a disk recording and/or reproducing device according to claim 1, wherein each of said tubular sleeves has an inner end proximate to said intermediate portion of said bearing axle, and an outer end opposite to said inner end, said outer end of a respective one of said tubular sleeves having an outer diameter that is greater than outer diameter of said inner end of the respective one of said tubular sleeves and that defines the greatest outer diameter of the respective one of said tubular sleeves.

5. The transport roller for a disk recording and/or reproducing device according to claim 1, wherein the disk recording and/or reproducing device includes a casing formed with an entrance-and-exist slot, the disk-like recording medium being drawn into by the transport roller or ejected from the casing via said entrance-and-exist slot, said bearing axle having a length greater than a longitudinal length of said entrance-and-exist slot.

6. The transport roller for a disk recording and/or reproducing device according to claim 1, wherein the disk recording and/or reproducing device is slot-in type.

7. The transport roller for a disk recording and/or reproducing device according to claim 6, wherein the disk-like recording medium is an optical disk.

8. The transport roller for a disk recording and/or reproducing device according to claim 1, wherein said spacer member includes two annular flanges respectively fixed on opposite sides of said intermediate portion of said bearing axle for spacing said tubular sleeves apart from each other.

9. The transport roller for a disk recording and/or reproducing device according to claim 1, wherein said spacer member is integrally formed on said intermediate portion of said bearing axle.

10. A disk recording and/or reproducing device comprising:
an optical reading/writing head for reading and storing information recorded in a disk-like recording medium;
an entrance-and-exit slot, said recording medium being drawn into or ejected from the recording and/or reproducing device via said entrance-and-exit slot; and
a transport roller disposed within the disk recording and/or reproducing device for drawing into and ejecting said recording medium from the recording and/or reproducing device, said transport roller including:
a bearing axle disposed within the disk recording and/or reproducing device, extending along left and right sides of the disk recording and/or reproducing device, and having left and right end portions and an intermediate portion between said left and right end portions,
two tubular sleeves sleeved respectively on outer surfaces of said left and right end portions of said bearing axle, and
a spacer member mounted on said intermediate portion of said bearing axle for spacing said tubular sleeves apart from each other, wherein said spacer member has an outer diameter that is greater than an outer diameter of said bearing axle and that is equivalent to or is smaller than the greatest outer diameter of a respective one of said tubular sleeves.

11. The disk recording and/or reproducing device according to claim 10, wherein each of said tubular sleeves is made from a resilient material.

12. The disk recording and/or reproducing device according to claim 10, wherein said resilient material is rubber.

13. The disk recording and/or reproducing device according to claim 10, wherein each of said tubular sleeves has an inner end proximate to said intermediate portion of said bearing axle and an outer end opposite to said inner end, said outer end of a respective one of said tubular sleeves having an outer diameter that is greater than outer diameter of said inner end of the respective one of said tubular sleeves and that defines the greatest outer diameter of the respective one of said tubular sleeves.

14. The disk recording and/or reproducing device according to claim 10, further comprising a casing formed with said entrance-and-exist slot, said bearing axle having a length greater than a longitudinal length of said entrance-and-exist slot.

15. The disk recording and/or reproducing device according to claim 10, wherein the disk recording and/or reproducing device is slot-in type.

16. The disk recording and/or reproducing device according to claim 15, wherein said disk-like recording medium is an optical disk.

17. The disk recording and/or reproducing device according to claim 10, wherein said spacer member includes two annular flanges respectively fixed on left and right sides of said intermediate portion of said bearing axle for spacing said tubular sleeves apart from each other.

18. The disk recording and/or reproducing device according to claim 10, wherein said spacer member is integrally formed on said intermediate portion of said bearing axle.
